(19) United States
(12) Patent Application Publication
(10) Pub. No.: US 2009/0114805 A1
(43) Pub. Date: May 7, 2009

(54) METHOD OF IDENTIFICATION OF PETROLEUM COMPOUNDS USING FREQUENCY MIXING ON SURFACES

(75) Inventor: Sebastian Csutak, Houston, TX (US)

Correspondence Address: CANTOR COLBURN LLP- BAKER ATLAS, 20 Church Street, 22nd Floor, Hartford, CT, 06103, US

(73) Assignee: BAKER HUGHES INCORPORATED, Houston, TX (US)

(21) Appl. No.: 11/933,538

(22) Filed: Nov. 1, 2007

(51) Int. Cl. G01V 5/08

(52) U.S. Cl. 250/269.1; 356/51; 356/317; 356/318

(57) ABSTRACT

A method for determining a chemical composition of a material in a borehole, the method including placing an analysis apparatus into the borehole; placing a sample of the material onto a metal surface of the apparatus; illuminating the sample at an interface between the sample and the metal surface with a first light beam and a second light beam; measuring sum frequency light generated from the illuminating; and analyzing the sum frequency light to determine the chemical composition of the material.

### BACKGROUND OF THE INVENTION

1. Field of the Invention

The invention disclosed herein relates to identifying the chemical composition of a material that is located in a borehole. In particular, analysis of the material is performed within the borehole.

2. Description of the Related Art

A variety of geologic formations contain reservoirs of petroleum. Measuring properties of the geologic formations provides information that can be useful for locating the reservoirs of petroleum. In addition, it is important to monitor the reservoirs that are already located. Monitoring provides information useful for optimizing production resources.

Generally, petroleum is accessed by drilling a borehole into the subsurface of the earth. The borehole also provides access for taking samples of materials from the borehole. The samples may be taken to the surface of the earth for analysis in a chemistry laboratory. The analysis is used to determine a chemical composition of a material in the borehole such as a petroleum compound. There are a few disadvantages to analyzing the samples in the laboratory. One disadvantage is that transporting the samples to the laboratory can be time consuming. Another disadvantage is that while samples are being withdrawn from the borehole other uses of the borehole may be precluded. One technique that can overcome these disadvantages is well logging.

Well logging is a technique used to tale measurements of the geologic formations and reservoirs from the borehole. In one embodiment, a logging instrument is lowered on the end of a wireline into the borehole. The logging instrument sends data via the wireline to the surface for recording. Output from the logging instrument comes in various forms and may be referred to as a “log.”

Therefore, what are needed are techniques for logging the chemical composition of a material in a borehole.

### BRIEF SUMMARY OF THE INVENTION

Disclosed is one example of a method for determining a chemical composition of a material in a borehole, the method including placing an analysis apparatus into the borehole; placing a sample of the material onto a metal surface of the apparatus; illuminating the sample at an interface between the sample and the metal surface with a first light beam and a second light beam; measuring sum frequency light generated from the illuminating; and analyzing the sum frequency generated light to determine the chemical composition of the material.

Also disclosed is an embodiment of a computer program product stored on machine readable media for determining a chemical composition of a material in a borehole, the product including machine executable instructions for placing an analysis apparatus into the borehole; placing a sample of the material onto a metal surface of the apparatus; illuminating the sample at an interface between the sample and the metal surface with a first light beam and a second light beam; measuring sum frequency generated light from the illuminating; and analyzing the sum frequency generated light to determine the chemical composition of the material.

Further disclosed is an embodiment of a logging instrument for determining a chemical composition of a material in a borehole, the instrument including an analysis apparatus that includes at least a metal surface, at least a first light source and a second light source, and at least one light detector; wherein the apparatus is adapted for receiving a sample of the material from a downhole environment onto the metal surface, illuminating the material, and measuring an intensity of sum frequency light emitted from the material.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging instrument in a borehole penetrating the earth;

FIG. 2 illustrates aspects of an exemplary embodiment of an analysis apparatus for performing a chemical analysis;

FIG. 3 illustrates an exemplary embodiment of the analysis apparatus for performing a chemical analysis;

FIG. 4 is an exemplary plot of a vibrational sum frequency spectrum;

FIG. 5 illustrates an exemplary embodiment of a plurality of analysis apparatus for performing a chemical analysis;

FIG. 6 illustrates an exemplary embodiment of the logging instrument connected to a computer; and

FIG. 7 presents one example of a method for analyzing a chemical composition of a material in the borehole.

### DETAILED DESCRIPTION OF THE INVENTION

The teachings provide techniques for accurately performing a chemical analysis of a material located within a borehole. A petroleum compound located in a reservoir can be identified using these techniques.

The techniques include an analysis apparatus for performing the chemical analysis. The analysis apparatus is placed in the borehole with a logging instrument to perform the chemical analysis. The analysis apparatus uses spectroscopy to analyze materials located within the borehole. In particular, the analysis apparatus performs sum frequency spectroscopy on a layer of material adsorbed to a metal surface.

Sum frequency spectroscopy is an optical technique that analyzes a material at an interface between the material and the metal surface. In sum frequency spectroscopy, two light beams, a first light beam and a second light beam, are directed at the interface. The angle each light beam makes with respect to the interface is generally not ninety degrees. The first light beam and the second light beam are directed so that the two light beams will overlap each other in space and time at the interface. One of the light beams has a frequency generally in the infrared region of the light spectrum. The other light beam has a frequency generally in the visible region of the light spectrum. Because of the overlap, an interaction between the first light beam and the second light beam will occur. From the interaction, a third light beam will be emitted from where the overlap occurs at the interface. The third light beam will have a frequency that is the sum of the frequencies of the first light beam and the second light beam. The angle that the third light beam makes with the interface is the angle required to conserve momentum. The third light beam is generated because a nonlinear optical phenomenon known as “sum frequency generation” or “three wave mixing.” The third light beam is referred to as the “sum frequency light beam” or “sum frequency light.”

The first light beam and the second light beam can be provided by lasers. In general, a laser providing the light beam in the infrared region is tunable while the laser providing the light beam in the visible region is fixed. When the frequency of the infrared laser is tuned, a frequency (resonant frequency) may be reached that is in resonance with a vibrational mode of the surface molecules of the material at the interface. At the resonant frequency, the intensity of the sum frequency beam is enhanced.

The sum frequency beam can be characterized by an intensity and a wavelength (or wavenumber). As the frequency of the light emitted from the infrared laser is varied, the intensity of the sum frequency beam can also vary. Plotting the intensity versus the wavelength for the sum frequency beam provides a “vibrational sum frequency (VSF) spectrum.”

The intensity of the sum frequency beam I(f₁+f₂) can be determined by equation (1)

I(f₁+f₂)=k|χ⁽²⁾eff|²I(f₁)I(f₂) (1)

where k represents a constant of proportionality, χ⁽²⁾ eff represents the effective second order electric susceptibility of the material being analyzed, I(f₁) represents the intensity of the first light beam at frequency f₁, and I(f₂) represents the intensity of the second light beam at frequency f₂. Because of molecular symmetry in the interior of a material away from a boundary, the effective second order electric susceptibility of the material is about zero. However, the boundary at the interface breaks the molecular symmetry of the material with the result that the effective second order electric susceptibility at the interface is non-zero. The effective second order electric susceptibility at the interface is determined by the molecular structure of the material. The molecular structure of the material is unique to the chemistry of the material. Therefore, the VSF spectrum is unique to the chemistry of the material. By obtaining the VSF spectrum of the material, the chemical composition of the material can be identified.

The VSF spectrum for various materials expected in the borehole can be at least one of calculated and obtained by experiment. The VSF spectrum determined for a known material compound is referred to as “reference VSF spectrum.” The VSF spectrum obtained from the analysis apparatus can be compared to reference VSF spectrums to determine the material compound producing the VSF spectrum.

For convenience, certain definitions are provided. The term “overlap” relates to the requirement that two light beams must generally occupy the same space at the same time in order to produce the sum frequency beam. The term “housing” relates to a structure of a logging instrument. The housing may used to at least one of contain and support the analysis apparatus.

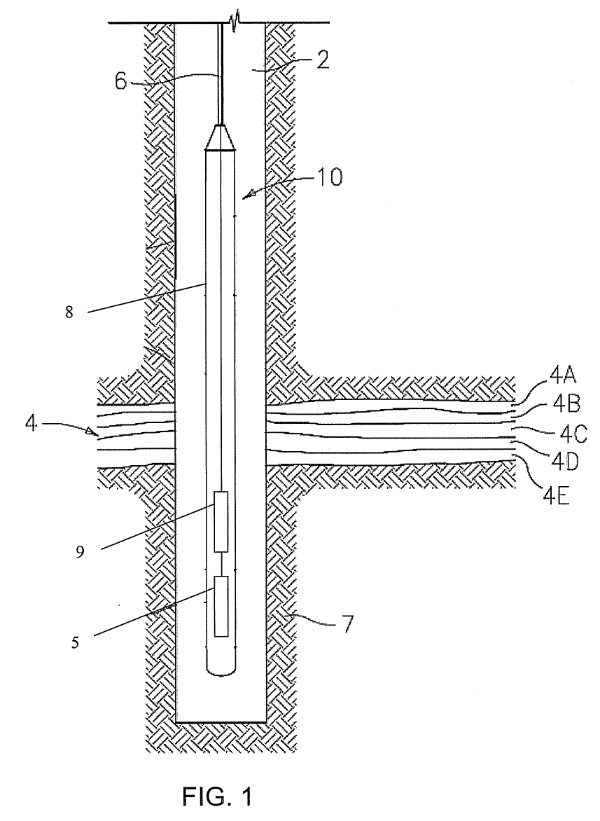

Referring to FIG. 1, a well logging instrument 10 is shown disposed in a borehole 2. The logging instrument 10 may be used for measuring at least one of characteristics of a formation and borehole parameters. The logging instrument 10 includes an instrument housing 8 adapted for use in the borehole 2. The borehole 2 is drilled through earth 7 and penetrates formations 4, which include various formation layers 4A-4E. The logging instrument 10 is typically lowered into and withdrawn from the borehole 2 by use of an armored electrical cable 6 or similar conveyance as is known in the art. An analysis apparatus 5 is disposed in the housing 8 as shown in FIG. 1. Also shown disposed in the housing 8 is an electronic unit 9. The electronic unit 9 is used for at least one of processing and recording output from the analysis apparatus 5.

In some embodiments, the borehole 2 includes materials such as would be found in oil exploration, including a mixture of materials such as water, drilling fluid, mud, petroleum compounds and formation fluids that are indigenous to the various formations. One skilled in the art will recognize that the various features as may be encountered in a subsurface environment may be referred to as “formations.” Accordingly, it should be considered that while the term “formation” generally refers to geologic formations of interest, that the term “formations,” as used herein, may, in some instances, include any geologic points of interest (such as a survey area).

For the purposes of this discussion, it is assumed that the borehole 2 is vertical and that the formations 4 are horizontal. The teachings herein, however, can be applied equally well in deviated or horizontal wells or with the formation layers 4A-4E at any arbitrary angle. The teachings are equally suited for use in logging while drilling (LWD) applications and in open-borehole and cased-borehole wireline applications. In LWD applications, the logging instrument 10 may be disposed in a drilling collar. When used in LWD applications, drilling may be halted temporarily to prevent vibrations while the analysis apparatus 5 is used to perform a measurement.

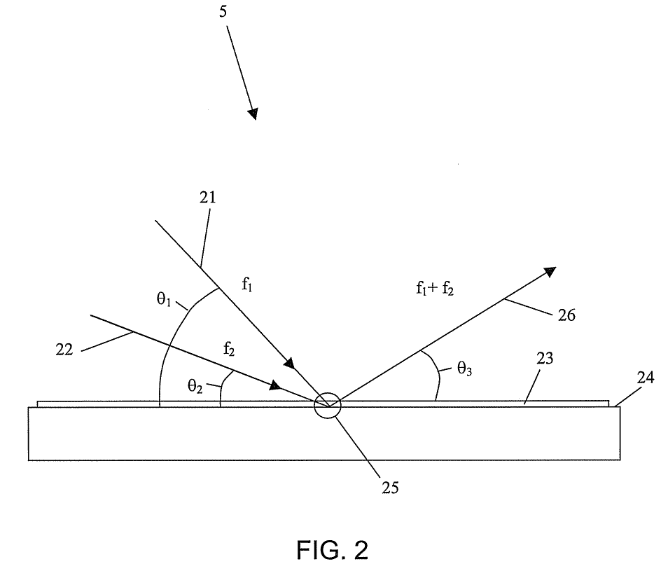

FIG. 2 depicts aspects of one embodiment of the analysis apparatus 5. Referring to FIG. 2, the analysis apparatus 5 provides a first light beam 21 with a frequency f₁ and a second light beam 22 with a frequency f₂. For teaching purposes, the frequency f₁ is selected to be in the infrared region of the light spectrum. The first light beam 21 is tunable over a range of frequencies in the infrared region. The second light beam 22 has frequency f₂ fixed in the visible light spectrum. As shown in FIG. 2, a layer of material 23 is disposed upon a metal surface 24. Also depicted in FIG. 2 is an interface 25 where the material 23 is adsorbed to the metal surface 24. An exemplary embodiment of the metal surface 24 is a platinum surface.

Referring to FIG. 2, the first light beam 21 and the second light beam 22 are directed so as to overlap at the interface 25. The first light beam makes an angle θ₁ with the metal surface 24. Similarly, the second light beam 22 makes an angle θ₂ with the metal surface 24. In general, the angles θ₁ and θ₂ are not ninety degrees. The first light beam 21 interacts with the second light beam 22 at the interface 25 to produce a sum frequency light beam 26 with frequency (f₁+f₂) and angle θ₃. The sum frequency light beam 26 is reflected from the metal surface 24 at the interface 25. The intensity I3 of the sum frequency light beam 26 is proportional to the intensity I1 of the first light beam 21, the intensity of the second light beam 22, and the square of the second order electric susceptibility of the material 23. The second order electric susceptibility of the material 23 is a function of the frequencies f₁ and f₂ and, therefore, will vary as f₁ varies. The angle θ₃ is the angle required to conserve momentum resulting from the three wave mixing.

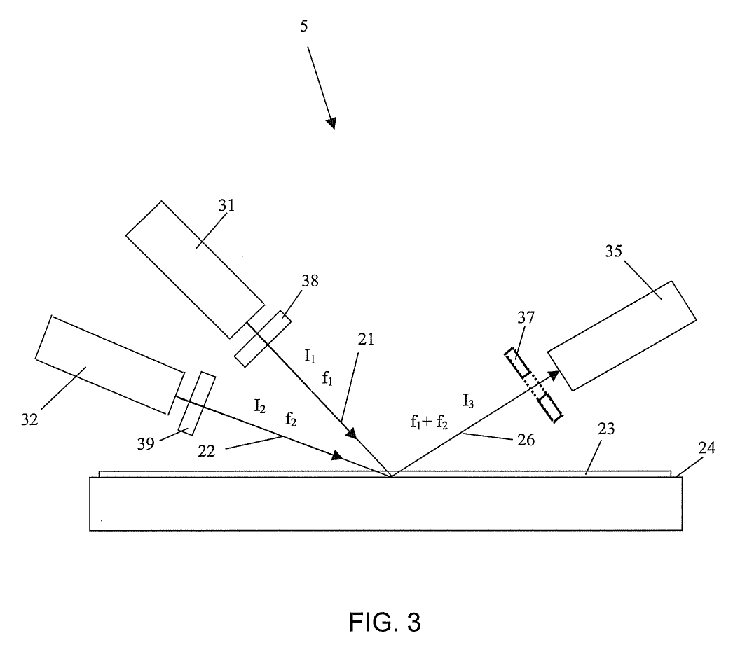

FIG. 3 illustrates an exemplary embodiment of the analysis apparatus 5. Referring to FIG. 3, a first light source 31 provides the first light beam 21 while a second light source 32 provides the second light beam 22. An exemplary embodiment of each of the first light source 31 and the second light source 32 is a laser. To exclude undesired frequencies of light in the first light beam 21 and the second light beam 22, the first light source 31 and the second light source 32 may each include an optical filter. In the embodiment of FIG. 3, a first optical filter 38 is shown associated with the first light source 31. Similarly, a second optical 39 filter is shown associated with the second light source 32. Each optical filter may also be used to polarize light transmitted through the optical filter.

Referring to FIG. 3, a light detector 35 is depicted for measuring the intensity I3 of the sum frequency light beam 26. Exemplary embodiments of the light detector 35 include at least one of a photomultiplier tube and a photodiode. In order to exclude any unwanted modes of light from entering the photodetector 35, an iris 37 is used to spatially filter light as shown in FIG. 3.

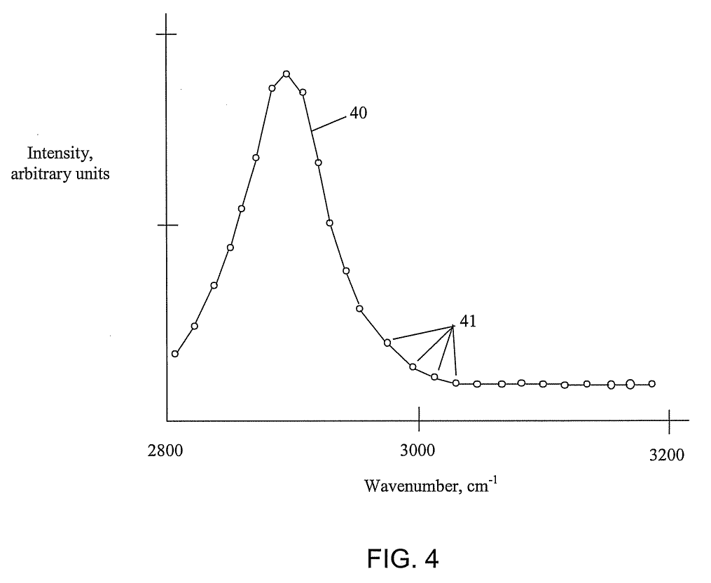

FIG. 4 is an exemplary plot of a VSF spectrum 40. In the plot of FIG. 4, twenty-six data points 41 are used to construct the VSF spectrum 40 for illustration purposes. Each of the data points 41 corresponds to the frequency f₁ (of the first light beam 21) that is varied in the infrared region. Increasing the number of data points 41 will increase the accuracy of the VSF spectrum 40.

An embodiment for analyzing a chemical composition of the material 23 in the borehole 2 may include a plurality of the analysis apparatus 5. Each of the analysis apparatus 5 in the plurality can have components such as the first light source 31, the second light source 32, and the light detector 35 made with solid state technology. Using solid state fabrication, components in the analysis apparatus 5 can better survive the rigors of a borehole environment. In this embodiment, the frequency for each of the first light beam 21 and the second light beam 22 is fixed. Because the frequency of each light beam is fixed, the number of analysis apparatus 5 in the plurality must be equal to or greater than the number of data points 41 desired to plot the VSF spectrum. For example, if sixty data points 41 are desired to plot the VSF spectrum, then at least sixty analysis apparatus 5 must be used in the plurality. By using solid state technology to make the components of the analysis apparatus 5, the analysis apparatus 5 can be made small enough so that the plurality of analysis apparatus 5 can be disposed within the logging instrument 10.

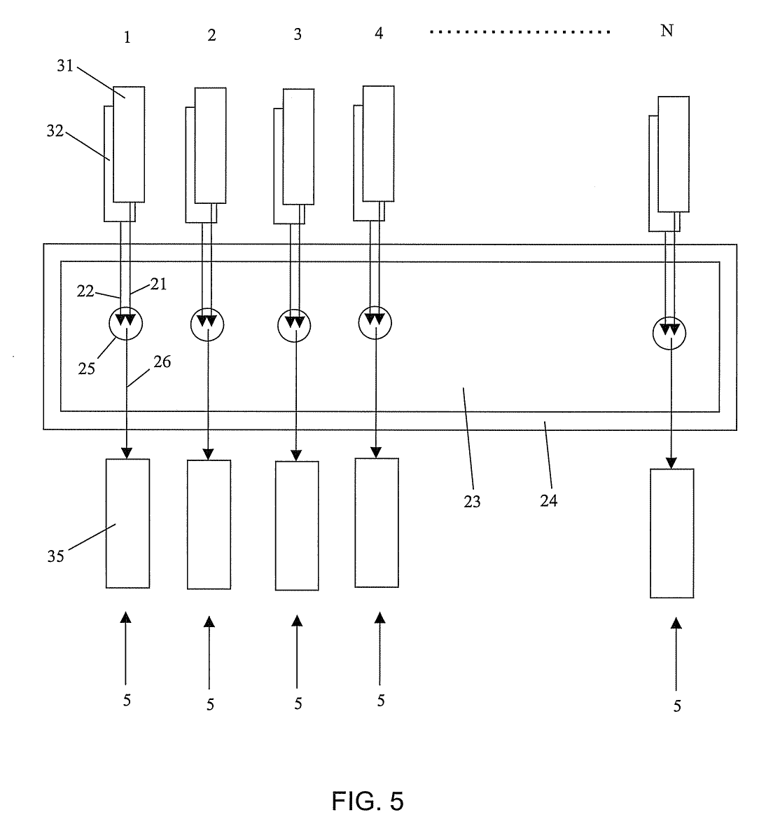

FIG. 5 illustrates a top view of an exemplary embodiment of an apparatus for analyzing a chemical composition of the material 23 in the borehole 2 using the plurality of the analysis apparatus 5. Referring to FIG. 5, N analysis apparatus 5 are included in the plurality. In the embodiment of FIG. 5, the plurality of the analysis apparatus 5 shares a common metal surface 24.

Generally, the well logging instrument 10 includes adaptations as may be necessary to provide for operation during drilling or after a drilling process has been completed.

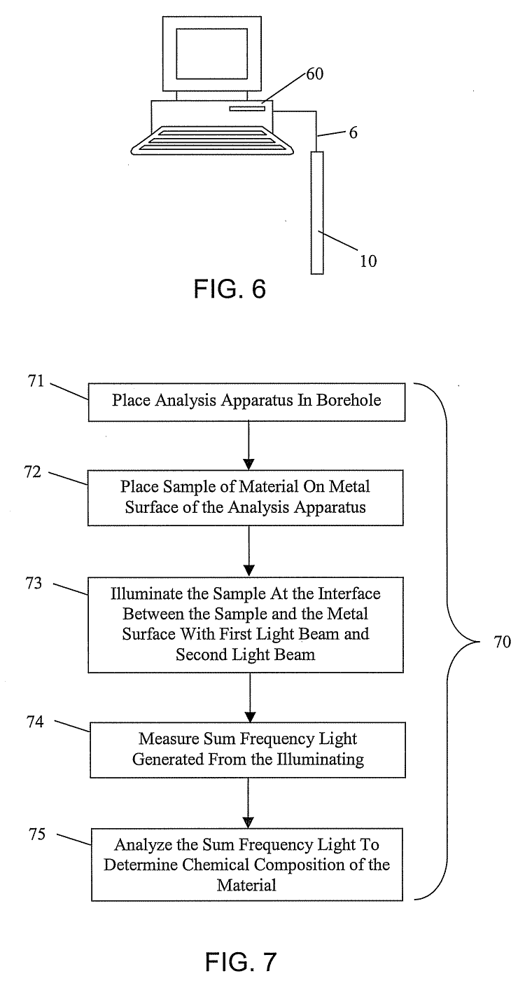

Referring to FIG. 6, an apparatus for implementing the teachings herein is depicted. In FIG. 6, the apparatus includes a computer 60 coupled to the well logging instrument 10. Typically, the computer 60 includes components as necessary to provide for the real time processing of data from the well logging instrument 10. Exemplary components include, without limitation, at least one processor, storage, memory, input devices, output devices and the like. As these components are known to those skilled in the art, these are not depicted in any detail herein.

Generally, some of the teachings herein are reduced to an algorithm that is stored on machine-readable media. The algorithm is implemented by the computer 60 and provides operators with desired output. The output is typically generated on a real-time basis.

The logging instrument 10 may be used to provide real-time measurements for the chemical analysis. As used herein, generation of data in “real-time” is taken to mean generation of data at a rate that is useful or adequate for making decisions during or concurrent with processes such as production, experimentation, verification, and other types of surveys or uses as may be opted for by a user or operator. Accordingly, it should be recognized that “real-time” is to be taken in context, and does not necessarily indicate the instantaneous determination of data, or make any other suggestions about the temporal frequency of data collection and determination.

A high degree of quality control over the data may be realized during implementation of the teachings herein. For example, quality control may be achieved through known techniques of iterative processing and data comparison. Accordingly, it is contemplated that additional correction factors and other aspects for real-time processing may be used. Advantageously, the user may apply a desired quality control tolerance to the data, and thus draw a balance between rapidity of determination of the data and a degree of quality in the data.

FIG. 7 presents one example of a method 70 for determining a chemical composition of the material 23 in the borehole 2. The method 70 calls for placing (step 71) the analysis apparatus 5 in the borehole 2. Further, the method 70 calls for placing (step 72) a sample of the material 23 onto the metal surface 24 of the apparatus 5. Further, the method 70 calls for illuminating (step 73) the sample at the interface 25 between the sample and the metal surface 24 with the first light beam 21 and the second light beam 22. Further, the method 70 calls for measuring (step 74) the sum frequency light 26 generated from the illuminating. Step 74 may include measuring the intensity I₃ of the sum frequency light 26. Further, the method 70 calls for analyzing (step 75) the sum frequency light 26 to determine the chemical composition of the material.

In certain embodiments, a string of two or more logging instruments 10 may be used where each logging instrument 10 includes at least one analysis apparatus 5. In these embodiments, the responses from each of the analysis apparatus 5 may be used separately or combined to produce a composite response.

In support of the teachings herein, various analysis components may be used, including digital and/or analog systems. For example, the digital and/or analog systems may be used for the electronic unit 9. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling unit, heating unit, motive force (such as a translational force, propulsional force or a rotational force), sensor, transmitter, receiver, transceiver, controller, optical unit, optical lens, electrical unit, electromechanical unit, sample pump, or sample line may be included in support of the various aspects discussed herein or in support of other functions beyond this disclosure.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for determining a chemical composition of a material in a borehole, the method comprising:
placing an analysis apparatus into the borehole;
placing a sample of the material onto a metal surface of the apparatus;
illuminating the sample at an interface between the sample and the metal surface with a first light beam and a second light beam;
measuring sum frequency light generated from the illuminating; and
analyzing the sum frequency light to determine the chemical composition of the material.

2. The method as in claim 1, wherein measuring comprises measuring an intensity of the sum frequency generated light.

3. The method as in claim 1, wherein the material comprises a petroleum compound.

4. The method as in claim 1, further comprising varying the frequency of the first light beam in the infrared region of the light spectrum while keeping constant the frequency of the second light beam in the visible region of the light spectrum.

5. The method as in claim 4, further comprising developing a vibrational sum frequency (VSF) spectrum for the material from the varying.

6. The method as in claim 5, wherein analyzing comprises comparing the VSF spectrum to a reference VSF spectrum to determine the chemical composition of the material.

7. A computer program product stored on machine readable media for determining a chemical composition of a material in a borehole, the product comprising machine executable instructions for:
placing an analysis apparatus into the borehole;
placing a sample of the material onto a metal surface of the apparatus;
illuminating the sample at an interface between the sample and the metal surface with a first light beam and a second light beam;
measuring sum frequency generated light from the illuminating; and
analyzing the sum frequency generated light to determine the chemical composition of the material.

8. A logging instrument for determining a chemical composition of a material in a borehole, the instrument comprising:
an analysis apparatus that includes at least a metal surface, at least a first light source and a second light source, and at least one light detector;
wherein the apparatus is adapted for receiving a sample of the material from a downhole environment onto the metal surface, illuminating the material, and measuring an intensity of sum frequency light emitted from the material.

9. The instrument as in claim 8, wherein at least one of the light sources provides light that can be tuned in substantially the infrared region of the light spectrum and at least one other of the light sources provides light at a substantially fixed frequency in the visible region of the light spectrum.

10. The instrument as in claim 8, wherein each of the light sources comprises a laser.

11. The instrument as in claim 8, wherein each of the light sources comprises a fixed frequency.

12. The instrument as in claim 8, wherein the at least one light detector comprises at least one of a photomultiplier tube and a photodiode.

13. The instrument as in claim 8, wherein the metal surface comprises platinum.

14. The instrument as in claim 8, wherein at least one of the light sources comprises a filter for providing light at at least one of a desired frequency and a desired polarization.

15. The instrument as in claim 8, further comprising an iris for spatially filtering light emitted from the material at the interface.

16. The instrument as in claim 8, further comprising an electronic unit for processing output from the at least one light detector.

17. The instrument as in claim 16, wherein the processing comprises developing a vibrational sum frequency (VSF) spectrum for the material.

18. The instrument as in claim 17, further comprising a reference VSF spectrum for a known chemical composition for comparison to the VSF spectrum for the material.

19. The instrument as in claim 18, wherein the reference VSF spectrum is developed by calculation.

20. The instrument as in claim 18, wherein the reference VSF spectrum is developed by experimentation.
